(19) United States
(12) Patent Application Publication
(10) Pub. No.: US 2001/0044511 A1
(43) Pub. Date: Nov. 22, 2001

(54) Polymerization of olefins

(76) Inventors: Steven Dale Ittle, Wilmington, DE (US); Ying Wang, West Chester, PA (US); Evgeniy Petrovich Ivakhnenko, Rostov-On-Don (RU)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/813,768

(22) Filed: Mar. 21, 2001

Related U.S. Application Data
(60) Provisional application No. 60/191,983, filed on Mar. 24, 2000.

(51) Int. Cl. C08F 4/44

(52) U.S. Cl. 526/161; 526/352

(57) ABSTRACT

Transition metal complexes of a monoanionic ligand derived from a selected o-(arylamino)benzalimine, and optionally in the presence of other cocatalysts, polymerize olefins. The resulting polymers are useful as elastomers and molding resins. Novel o-(arylamino)benzalimines and a method of making them are also disclosed.

### CROSS-REFERENCE TO RELATED APPLICATION

This application claims priority under 35 U.S.C. §119 from U.S. Provisional Application Ser. No. 60/191,983 (filed Mar. 24, 2000), which is incorporated by reference herein for all purposes as if fully set forth.

### FIELD OF THE INVENTION

Olefins are polymerized by contacting them with a transition metal complex of a monoanionic ligand derived from a selected o-(arylamino)benzalimine, and optionally other co-catalysts. Also disclosed are novel o-(arylamino)-benzalimines and a method of making them.

### TECHNICAL BACKGROUND

Olefins may be polymerized by a variety of transition metal containing catalysts, for example metallocene and Ziegler-Natta type catalysts. More recently, other types of transition metal containing polymerization catalysts have been discovered, in which the transition metal atom is complexed to a neutral or monoanionic ligand. See, for instance, U.S. Pat. Nos. 5,714,556, 5,852,145, 5,880,241, 5,929,181, 5,932,670, 5,942,461, 5,955,555, 6,060,569, 6,103,658, 6,174,975, WO96/37522, WO97/23492, WO97/48735, WO98/30612, WO98/37110, WO98/38228, WO98/40420, WO98/42664, WO98/42665, WO98/47934, WO99/49969, WO99/41290, WO99/51550, WO00/50470, JP-A-09255712, JP-A-09255713, JP-A-11158213, JP-A-11180991, JP-A-11209426, EP-A-0893455 and EP-A-0924223, all of which are hereby included by reference for all purposes as if fully set forth. Each type of polymerization catalyst has its advantages and disadvantages, and due the commercial importance of polyolefins, new polymerization catalysts are constantly being sought.

### SUMMARY OF THE INVENTION

This invention concerns a process for the polymerization of olefins, comprising the step of contacting, at a temperature of about −100° C. to about +200° C., one or more monomers selected from the group consisting of ethylene and an olefin of the formula H₂C═CH(CH₂)ₙG (XVII), with a Ni, Pd, Co, Fe, Cr, V, Zr, Ti or Hf complex of an anion of the formula (I)

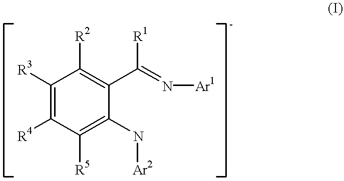

wherein:

R¹ is hydrogen, hydrocarbyl or substituted hydrocarbyl;

R², R³, R⁴, and R⁵ are each independently hydrogen, hydrocarbyl, substituted hydrocarbyl or a functional group, provided that R¹ and R² taken together may form a ring, or any two of R², R³, R⁴ and R⁵ vicinal to one another may form a ring;

Ar¹ and Ar² are each independently aryl or substituted aryl, provided that R⁵ and Ar² taken together may form a ring;

n is an integer of 1 or more;

G is hydrogen, —CO₂R¹⁶, or —C(O)N¹⁶₂; and

each R¹⁶ is independently hydrogen, hydrocarbyl or substituted hydrocarbyl.

Also described herein is a process for the polymerization of olefins, comprising the step of contacting, at a temperature of about −100° C. to about +200° C., one or more monomers selected from the group consisting of ethylene and H₂C═CH(CH₂)ₙG (XVII), with a compound of the formula (II)

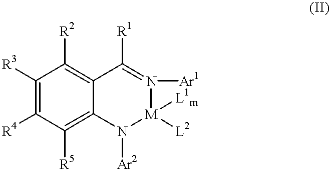

wherein

R¹, R², R³, R⁴, R⁵, Ar¹, Ar², n and G (and all groups asociated therewith) are as defined above for (I);

M is Ni, Pd, Co, Fe, Cr, V, Ti, Zr or Hf;

m is an integer equal to the valence of M minus 1; and

each L¹ is independently a monodentate monoanionic ligand and at least for one of L¹ an ethylene molecule may insert between L¹ and M, and L² is a monodentate neutral ligand which may be displaced by ethylene or an empty coordination site, provided that an L¹ and L² taken together may be a monoanionic bidentate ligand and at least for one of these monoanionic bidentate ligands ethylene may insert between said monoanionic bidentate ligand and M.

In the above-mentioned processes, (II) and/or the transition metal complex of (I) may in and of themselves be active catalysts, or may be “activated” by contact with a cocatalyst/activator.

This invention also concerns a compound of the formula (XVIII)

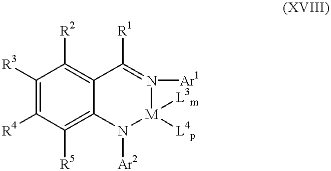

wherein:

R¹, R², R³, R⁴, R⁵, Ar¹, Ar², M and m are as defined above for (II);

p is 0 or 1;

each L³ is independently a monodentate monoanionic ligand, and L⁴ is a monodentate neutral ligand or an empty coordination site, provided that an L³ and L⁴ taken together may be a monoanionic bidentate ligand.

Also disclosed herein is a compound of the formula (III)

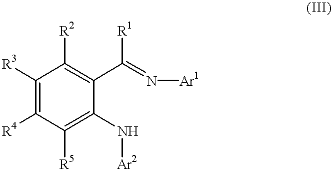

wherein R¹, R², R³, R⁴, R⁵, Ar¹ and Ar² are as defined above for (I).

Another novel moiety in accordance with the present invention is an anion of the formula (I)

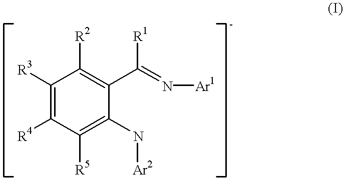

wherein R¹, R² R³ R⁴ R⁵, Ar¹ and Ar² are as defined above.

These and other features and advantages of the present invention will be more readily understood by those of ordinary skill in the art from a reading of the following detailed description. It is to be appreciated that certain features of the invention which are, for clarity, described below in the context of separate embodiments, may also be provided in combination in a single embodiment. Conversely, various features of the invention which are, for brevity, described in the context of a single embodiment, may also be provided separately or in any subcombination.

### DETAILED DESCRIPTION OF THE PREFERRED EMBODIMENTS

Herein, certain terms are used. Some of them are:

A “hydrocarbyl group” is a univalent group containing only carbon and hydrogen. As examples of hydrocarbyls may be mentioned unsubstituted alkyls, cycloalkyls and aryls. If not otherwise stated, it is preferred that hydrocarbyl groups herein contain 1 to about 30 carbon atoms.

By “substituted hydrocarbyl” herein is meant a hydrocarbyl group that contains one or more (types of) substituents that do not substantially interfere with the operation of the polymerization catalyst system. Suitable substituents in some polymerizations may include some or all of halo, ester, keto (oxo), amino, imino, carboxyl, phosphite, phosphonite, phosphine, phosphinite, thioether, amide, nitrile, and ether. Preferred substituents when present are halo, ester, amino, imino, carboxyl, phosphite, phosphonite, phosphine, phosphinite, thioether, and amide. Which substituents are useful in which polymerizations may in some cases be determined by reference to U.S. Pat. No. 5,880,241 (incorporated by reference herein for all purposes as if fully set forth). If not otherwise stated, it is preferred that substituted hydrocarbyl groups herein contain 1 to about 30 carbon atoms. Included in the meaning of “substituted” are chains or rings containing one or more heteroatoms, such as nitrogen, oxygen and/or sulfur, and the free valence of the substituted hydrocarbyl may be to the heteroatom. In a substituted hydrocarbyl, all of the hydrogens may be substituted, as in trifluoromethyl.

By “(inert) functional group” herein is meant a group other than hydrocarbyl or substituted hydrocarbyl that is inert under the process conditions to which the compound containing the group is subjected. The functional groups also do not substantially interfere with any process described herein that the compound in which they are present may take part in. Examples of functional groups include some halo groups (for example fluoro and some unactivated chloro) ether such as —OR²² wherein R² is hydrocarbyl or substituted hydrocarbyl. In cases in which the functional group may be near a metal atom, the functional group should not coordinate to the metal atom more strongly than the groups in those compounds are shown as coordinating to the metal atom, that is they should not displace the desired coordinating group.

By an “activator”, “cocatalyst” or a “catalyst activator” is meant a compound that reacts with a transition metal compound to form an activated catalyst species. This transition metal compound may be added initially, or may be formed in situ, as by reaction of a transition metal compound with an oxidizing agent. A preferred catalyst activator is an “alkyl aluminum compound”, that is, a compound which has at least one alkyl group bound to an aluminum atom. Other groups such as, for example, alkoxide, hydride and halogen, may also be bound to aluminum atoms in the compound.

By “neutral Lewis base” is meant a compound, which is not an ion, that can act as a Lewis base. Examples of such compounds include ethers, amines, sulfides, olefins and organic nitrites.

By “neutral Lewis acid” is meant a compound, which is not an ion, that can act as a Lewis acid. Examples of such compounds include boranes, alkylaluminum compounds, aluminum halides and antimony [V] halides.

By “cationic Lewis acid” is meant a cation that can act as a Lewis acid. Examples of such cations are sodium and silver cations.

By an “empty coordination site” is meant a potential coordination site on a metal atom that does not have a ligand bound to it. Thus if an ethylene molecule is in the proximity of the empty coordination site, the ethylene molecule may coordinate to the metal atom.

By a “ligand into which an ethylene molecule may insert” between the ligand and a metal atom, or a “ligand that may add to ethylene”, is meant a ligand coordinated to a metal atom (which forms a bond L-M) into which an ethylene molecule (or a coordinated ethylene molecule) may insert to start or continue a polymerization. For instance, this may take the form of the reaction (wherein L is a ligand):

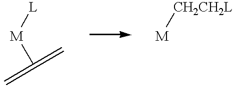

By a “ligand which may be displaced by ethylene” is meant a ligand coordinated to a transition metal, which when exposed to ethylene is displaced as the ligand by the ethylene.

By a “monoanionic ligand” is meant a ligand with one negative charge.

By a “neutral ligand” is meant a ligand that is not charged.

“Alkyl group” and “substituted alkyl group” have their usual meaning (see above for substituted under substituted hydrocarbyl). Unless otherwise stated, alkyl groups and substituted alkyl groups preferably have 1 to about 30 carbon atoms.

By “aryl” is meant a monovalent aromatic group in which the free valence is to the carbon atom of an aromatic ring. An aryl may have one or more aromatic rings which may be fused, connected by single bonds or other groups.

By “substituted aryl” is meant a monovalent aromatic group substituted as set forth in the above definition of “substituted hydrocarbyl”. Similar to an aryl, a substituted aryl may have one or more aromatic rings which may be fused, connected by single bonds or other groups; however, when the substituted aryl has a heteroaromatic ring, the free valence in the substituted aryl group can be to a heteroatom (such as nitrogen) of the heteroaromatic ring instead of a carbon.

By a “π-allyl group” is meant a monoanionic ligand with 1 sp³ and two adjacent sp² carbon atoms bound to a metal center in a delocalized η³ fashion. The three carbon atoms may be substituted with other hydrocarbyl groups or functional groups.

The polymerizations herein are carried out by a transition metal complex of anion (I). In (I), and in all complexes and compounds containing (I) or its parent conjugate acid, it is preferred that:

R¹ is hydrogen; and/or

R², R³, R⁴, and R⁵ are hydrogen; and/or

Ar¹ and Ar² are each independently

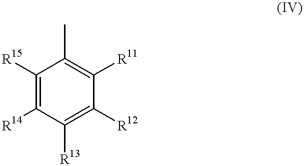

wherein each of R¹¹, R¹², R¹³, R¹⁴ and R¹⁵ are independently hydrogen, hydrocarbyl, substituted hydrocarbyl or a functional group, provided that any two of R¹¹, R¹², R¹³, R¹⁴ and R¹⁵ vicinal to one another taken together may form a ring. In one particularly preferred form both R¹¹ and R15 are not hydrogen, and/or R¹², R¹³ and R¹⁴ are hydrogen. In another preferred form R¹¹ and R¹⁵ are each independently chosen from the group consisiting of alkyl containing 1 to 4 carbon atoms, alkoxy, phenyl and halo, and especially preferably they are both alkyl containing 1 to 4 carbon atoms.

In specific anions (I) (and its conjugate acid) it is preferred that:

R¹, R², R³, R⁴, and R⁵ are hydrogen;

Ar¹ and Ar² are each independently (IV);

in Ar¹, R¹², R¹³ and R¹⁴ are hydrogen and R¹¹ and R¹⁵ are alkyl containing 1 to 4 carbons atoms, more preferably both R¹¹ and R¹⁵ are i-propyl or ethyl; and

in Ar², R¹², R¹³ and R¹⁴ are hydrogen and R¹¹ and R¹⁵ are alkyl containing 1 to 4 carbons atoms, more preferably both R¹¹ and R¹⁵ are methyl or ethyl.

All of the complexes of (I) may be made from the corresponding arylaminoimine (III)

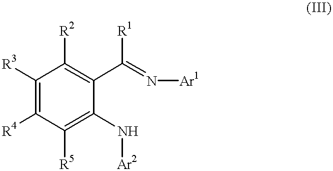

In turn (III) may be made by the process described below.

In a process to make (III) an appropriately substituted anthranilic acid (V)

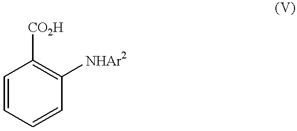

(preferred substitution is the same as in (I)), is prepared by reacting an arylamine Ar²NH₂ (VI) with o-bromobenzoic acid in the presence of a suitable catalyst. (V) is then reacted with a suitable reagent, such as thionyl chloride, to convert it to the corresponding acyl halide (or its hydrohalide salt), which is then reacted with an arylsulfonylhydrazine, such as p-toluenesulfonylhydrazine, to form the corresponding arylsulfonylhydrazide (VIII), wherein Ar³ is aryl or substituted aryl.

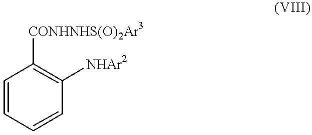

(VIII) is then thermolyzed in the presence of a base (for example Na₂CO₃) to form the corresponding aldehyde (IX). This reaction to make an aromatic aldehyde is described in J. S. McFadyen, et al., J. Chem. Soc., p. 584-587 (1936), which is hereby included by reference.

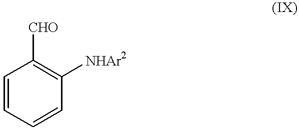

Finally, (IX) is reacted with a suitably substituted arylamine Ar¹NH₂ (X), preferably in the presence of an acid catalyst, to form (III). Illustrations of these reactions are found in the Examples.

Herein (III) may be converted to a transition metal complex such as (II), and in turn (II) may be useful directly as an olefin polymerization catalyst, or may be converted to an active polymerization catalyst by reaction with one or more other compounds (so-called cocatalysts). Thus (III) may be converted to its anion by reaction with a strong base such as sodium hydride or lithium bis(trimethylsilyl)amide, and this anion (I) may be reacted with an appropriate transition metal compound to form (XVIII). Useful nickel (and other analogous transition metal) compounds include:

(Ph₃P)₂Ni(Ph) (Cl) which gives (II) in which L¹ is Ph, and L² is Ph₃P;

(TMEDA)₂Ni(Ph) (Cl) in the presence of a “trapping ligand” L² such as pyridine, which specifically gives (II) for instance in which L¹ is Ph, and L² is pyridine;

(Ph₃P)₂NiCl₂ which gives (II) in which L¹ is Cl, and L² is Ph₃P; and

[(allyl)Ni(X)]₂ which gives (II) in which L¹ and L² taken together are π-allyl.

Methods of synthesis of these types of complexes may also be found in previously incorporated U.S. Pat. No. 6,060,569, 6,174,975 and WO9842664, and R. H. Grubbs., et al., Organometallics, vol. 17, p. 3149 (1988), also included herein by reference. If (XVIII) is not already equivalent to (II), it may be converted to (II) before or during the polymerization process by reaction with other appropriate compounds (such as cocatalysts).

As implied above, (I) will normally be associated with a positively charged species, such as a cation. This may be a transition metal cation [as in (II)], or may be another cation such as an alkali metal cation.

In (II) useful groups L¹ include halide (especially chloride), hydrocarbyl and substituted hydrocarbyl (especially phenyl and alkyl, and particularly phenyl, methyl, hydride and acyl). Useful groups for L² include phosphine such as triphenylphosphine, nitrile such as acetonitrile, ethers such as ethyl ether, pyridine, and tertiary alkylamines such as triethylamine and TMEDA (N,N,N′,N′-tetramethyl-1,2-ethylenediamine) . Alternatively L¹ and L² taken together may be a π-allyl or π-benzyl group such as

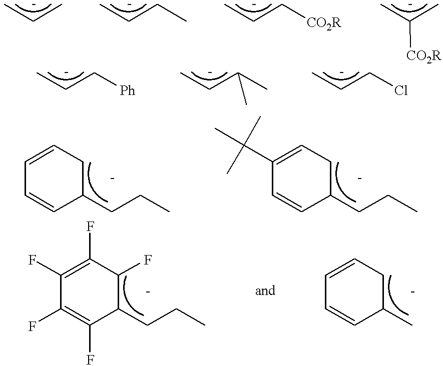

wherein R is hydrocarbyl, and π-allyl and π-benzyl groups are preferred.

In another variation, L³ and L⁴ taken together may be a β-diketonate ligand. If this ligand is present in (XVIII), it may be converted to (II) by use of a suitable alkylating agent such as an alkylaluminum compound, Grignard reagent or alkyllithium compound.

In (II) when ethylene may insert between L¹ and the transition metal atom, and L² is an empty coordination site or is a ligand which may be displaced by ethylene, or L¹ and L² taken together are a bidentate monoanionic ligand into which ethylene may be inserted between that ligand and the transition metal atom, (II) may by itself catalyze the polymerization of an olefin. Examples of L¹ which form a bond with the metal into which ethylene may insert between it and the transition metal atom are hydrocarbyl and substituted hydrocarbyl, especially phenyl and alkyl, and particularly methyl, hydride, and acyl. Ligands L² which ethylene may displace include phosphine such as triphenylphosphine, nitrile such as acetonitrile, ether such as ethyl ether, pyridine, tertiary alkylamines such as TMEDA, and other olefins. Ligands in which L¹ and L² taken together are a bidentate monoanionic ligand into which ethylene may insert between that ligand and the transition metal atom include π-allyl-or π-benzyl-type ligands (in this instance, sometimes it may be necessary to add a neutral Lewis acid cocatalyst such as triphenylborane to initiate the polymerization, see for instance previously incorporated U.S. Pat. No. 6,174,975). For a summary of which ligands ethylene may insert into (between the ligand and transition metal atom) see for instance J. P. Collman, et al., Principles and Applications of Organotransition Metal Chemistry, University Science Books, Mill Valley, Calif., 1987, included herein by reference. If for instance L¹ is not a ligand into which ethylene may insert between it and the transition metal atom, it may be possible to add a cocatalyst which may convert L¹ into a ligand which will undergo such an insertion. Thus if L¹ is halo such as chloride or bromide, or carboxylate, it may be converted to hydrocarbyl such as alkyl by use of a suitable alkylating agent such as an alkylaluminum compound, a Grignard reagent or an alkyllithium compound. It may be converted to hydride by use of a compound such as sodium borohydride.

As indicated above, when L¹ and L² taken together are a monoanionic polydentate ligand, a cocatalyst (sometimes also called an activator) which is an alkylating or hydriding agent is also typically present in the olefin polymerization. A preferred cocatalyst is an alkylaluminum compound, and useful alkylaluminum compounds include trialkylaluminum compounds such as triethylaluminum, trimethylaluminum and tri-iso-butylaluminum, alkyl aluminum halides such as diethylaluminum chloride and ethylaluminum dichloride, and aluminoxanes such as methylaluminoxane. More than one such co-catalyst may be used in combination.

In the transition metal compounds herein (and in the corresponding polymerization processes) it is preferred that the transition metal is nickel or palladium, more preferably nickel, and especially preferably nickel[II] wherein in complexes such as (II), m is 1. A preferred olefin is ethylene, and when olefins other than ethylene are polymerized, it is preferred that they be copolymers with ethylene. In other preferred olefins n is 1 to 20, and/or G is hydrogen, and/or G is —CO₂R¹⁶ wherein R¹⁶ is hydrocarbyl or substituted hydrocarbyl, especially alkyl.

In (XVIII) in one preferred form at least one of L³ is a ligand into which ethylene may insert between L³ and the transition metal atom, and L⁴, is an empty coordination site or a ligand which may be displaced by ethylene. In another preferred for of (XVIII) each of L³ is a ligand into which ethylene may not insert between that ligand and the transition metal atom, such as halide, especially chloride, and carboxylate.

In the polymerization processes herein, the temperature at which the polymerization is carried out is about −100° C. to about +200° C., preferably about −60° C. to about 150° C., more preferably about −20° C. to about 100° C. The pressure of the ethylene at which the polymerization is carried out is not critical, atmospheric pressure to about 275 MPa being a suitable range.

The polymerization processes herein may be run in the presence of various liquids, particularly aprotic organic liquids. The catalyst system, ethylene or other olefinic monomer, and/or polymer may be soluble or insoluble in these liquids, but obviously these liquids should not prevent the polymerization from occurring. Suitable liquids include alkanes, cycloalkanes, selected halogenated hydrocarbons, and aromatic hydrocarbons. Specific useful solvents include hexane, toluene, benzene methylene chloride, and 1,2,4-trichlorobenzene.

The ethylene polymerizations herein may also initially be carried out in the “solid state” by, for instance, supporting the nickel compound on a substrate such as silica or alumina, activating if necessary it with one or more cocatalysts and contacting it with the monomer(s). Alternatively, the support may first be contacted (reacted) with a cocatalyst (if needed) such as an alkylaluminum compound, and then contacted with an appropriate transition metal compound. The support may also be able to take the place of a Lewis or Bronsted acid, for instance an acidic clay such as montmorillonite, if needed. These “heterogeneous” catalysts may be used to catalyze polymerization in the gas phase or the liquid phase. By “gas phase” is meant that a gaseous olefin is transported to contact with the catalyst particle.

In all of the polymerization processes described herein oligomers and polymers of ethylene are made. They may range in molecular weight from oligomeric POs (polyolefins), to lower molecular weight oils and waxes, to higher molecular weight POs. One preferred product is a POs with a degree of polymerization (DP) of about 10 or more, preferably about 40 or more. By “DP” is meant the average number of repeat units in a PO molecule.

Depending on their properties, the POs made by the processes described herein are useful in many ways. For instance if they are thermoplastics, they may be used as molding resins, for extrusion, films, etc. If they are elastomeric, they may be used as elastomers. If they contain functionalized monomers such as acrylate esters, they are useful for other purposes. See for instance previously incorporated U.S. Pat. No. 5,880,241.

Depending on the process conditions used and the polymerization catalyst system chosen, the POs may have varying properties. Some of the properties that may change are molecular weight and molecular weight distribution, crystallinity, melting point, and glass transition temperature. Except for molecular weight and molecular weight distribution, branching can affect all the other properties mentioned, and branching may be varied (using the same nickel compound) using methods described in previously incorporated U.S. Pat. No. 5880241.

It is known that blends of distinct polymers, that vary for instance in the properties listed above, may have advantageous properties compared to “single” polymers. For instance it is known that polymers with broad or bimodal mosecular weight distributions may be melt processed (be shaped) more easily than narrower molecular weight distribution polymers. Thermoplastics such as crystalline polymers may often be toughened by blending with elastomeric polymers.

Therefore, methods of producing polymers which inherently produce polymer blends are useful especially if a later separate (and expensive) polymer mixing step can be avoided. However in such polymerizations one should be aware that two different catalysts may interfere with one another, or interact in such a way as to give a single polymer.

In such a process the transition metal containing polymerization catalyst disclosed herein can be termed the first active polymerization catalyst. A second active polymerization catalyst (and optionally one or more others) is used in conjunction with the first active polymerization catalyst. The second active polymerization catalyst may be another late transition metal catalyst, for example as described in previously incorporated U.S. Pat. Nos. 5,880,241, 5,714,556, 5,955,555, 6,060,569 and 6,174,975.

Other useful types of catalysts may also be used for the second active polymerization catalyst. For instance so-called Ziegler-Natta and/or metallocene-type catalysts may also be used. These types of catalysts are well known in the polyolefin field, see for instance Angew. Chem., Int. Ed. Engl., vol. 34, p. 1143-1170 (1995), EP-A-0416815 and U.S. Pat. No. 5,198,401 for information about metallocene-type catalysts, and J. Boor Jr., Ziegler-Natta Catalysts and Polymerizations, Academic Press, New York, 1979 for information about Ziegler-Natta-type catalysts, all of which are hereby included by reference. Many of the useful polymerization conditions for all of these types of catalysts and the first active polymerization catalysts coincide, so conditions for the polymerizations with first and second active polymerization catalysts are easily accessible. Oftentimes the “co-catalyst” or “activator” is needed for metallocene or Ziegler-Natta-type polymerizations. In many instances the same compound, such as an alkylaluminum compound, may be used as an “activator” for some or all of these various polymerization catalysts.

In one preferred process described herein the first olefin(s) (olefin(s) polymerized by the first active polymerization catalyst) and second olefin(s) (olefin(s) polymerized by the second active polymerization catalyst) are identical. The second olefin may also be a single olefin or a mixture of olefins to make a copolymer.

In some processes herein the first active polymerization catalyst polymerizes a monomer that may not be polymerized by said second active polymerization catalyst, and/or vice versa. In that instance two chemically distinct polymers may be produced. In another scenario two monomers would be present, with one polymerization catalyst producing a copolymer, and the other polymerization catalyst producing a homopolymer.

Likewise, conditions for such polymerizations, using catalysts of the second active polymerization type, will also be found in the appropriate above mentioned references.

Two chemically different active polymerization catalysts are used in this polymerization process. The first active polymerization catalyst is described in detail above. The second active polymerization catalyst may also meet the limitations of the first active polymerization catalyst, but must be chemically distinct. For instance, it may utilize a ligand that differs in structure between the first and second active polymerization catalysts. In one preferred process, the ligand type and the metal are the same, but the ligands differ in their substituents.

Included within the definition of two active polymerization catalysts are systems in which a single polymerization catalyst is added together with another ligand, preferably the same type of ligand, which can displace the original ligand coordinated to the metal of the original active polymerization catalyst, to produce in situ two different polymerization catalysts.

The molar ratio of the first active polymerization catalyst to the second active polymerization catalyst used will depend on the ratio of polymer from each catalyst desired, and the relative rate of polymerization of each catalyst under the process conditions. For instance, if one wanted to prepare a “toughened” thermoplastic polyethylene that contained 80% crystalline polyethylene and 20% rubbery polyethylene, and the rates of polymerization of the two catalysts were equal, then one would use a 4:1 molar ratio of the catalyst that gave crystalline polyethylene to the catalyst that gave rubbery polyethylene. More than two active polymerization catalysts may also be used if the desired product is to contain more than two different types of polymer.

The polymers made by the first active polymerization catalyst and the second active polymerization catalyst may be made in sequence, i.e., a polymerization with one (either first or second) of the catalysts followed by a polymerization with the other catalyst, as by using two polymerization vessels in series. However it is preferred to carry out the polymerization using the first and second active polymerization catalysts in the same vessel(s), i.e., simultaneously. This is possible because in most instances the first and second active polymerization catalysts are compatible with each other, and they produce their distinctive polymers in the other catalyst's presence. Any of the processes applicable to the individual catalysts may be used in this polymerization process with 2 or more catalysts, i.e., gas phase, liquid phase, continuous, etc.

The polymers produced by this process may vary in molecular weight and/or molecular weight distribution and/or melting point and/or level of crystallinity, and/or glass transition temperature and/or other factors. The polymers produced are useful as molding and extrusion resins and in films as for packaging. They may have advantages such as improved melt processing, toughness and improved low temperature properties.

Catalyst components which include transition metal complexes of (I), with or without other materials such as one or more cocatalysts and/or other polymerization catalysts are also disclosed herein. For example, such a catalyst component could include the transition metal complex supported on a support such as alumina, silica, a polymer, magnesium chloride, sodium chloride, etc., with or without other components being present. It may simply be a solution of the Ni complex, or a slurry of the Ni complex in a liquid, with or without a support being present.

Hydrogen or other chain transfer agents such as silanes (for example trimethylsilane or triethylsilane) may be used to lower the molecular weight of polyolefin produced in the polymerization process herein. It is preferred that the amount of hydrogen present be about 0.01 to about 50 mole percent of the olefin present, preferably about 1 to about 20 mole percent. The relative concentrations of a gaseous olefin such as ethylene and hydrogen may be regulated by varying their partial pressures.

In the Examples, all pressures are gauge pressures. Branching was determined by ¹H NMR, taking the total of the methyl carbon atoms as the number of branches. Branching is uncorrected for end groups. The following abbreviations are used:

DMF—N,N-dimethylformamide

Me—methyl

MMAO—modified methylaluminoxane

Mn—number average molecular weight

Mw—weight average molecular weight

PE—polyethylene

THF—tetrahydrofuran

### EXAMPLE 1

A mixture of 40.2 g (0.2 mol) o-bromobenzoic acid, 27.7 g (0.2 mol) anhydrous potassium carbonate, 0.5 g granulated CuO and 125 ml (1.0 mol) freshly distilled 2,6-dimethylaniline in a 1l, three-necked flask equipped with a stirrer and a condenser was carefully heated before vigorous evolution of carbon dioxide took place and a voluminous precipitate of potassium o-bromobenzoate formed. After this stage of the reaction ended the condenser was removed and heating was continued with passing of a slow stream of N₂ over the reaction mixture to remove water vapor formed in the course of the reaction. After 2-3 h at 150-160° C., the solids completely dissolved and evolution of CO₂ stopped. The brownish reaction mixture was cooled to ambient temperature and poured into 1l of water. The upper layer (unreacted aniline) was separated, and the water layer was washed with 100 ml of ether and acidified with HCl to pH 2-3. The solid product was filtered, washed with hot water, dried at 100° C., dissolved in 500 ml of methanol and filtered. The dark filtrate was concentrated before a crystalline compound began to precipitate. After cooling to −20° C. the product was filtered and dried. The crystallization may be repeated if necessary. Yield 33.8 g (70%) of light yellow crystals with m.p. 208-9° C. IR (nujol): 3327 (NH), 1732 (C=0), 1673, 1605, 1564. ¹H NMR (CDCl₃) 2.30 (s, 6H), 6.31 (1H, d, J=8,3 Hz), 6.75 (1H, t, J=7,6 Hz), 7.23 (3H, m), 7.34 (1H, t, J=7,20 Hz), 8.13 (1H, dd, J=1.65 Hz, 8.1 Hz), 8.98 (1H, s, NH), 12.2 (1H, broad s, COOH).

### EXAMPLE 2

In an analogous manner as in Example 1, N-(2,6-diethylphenyl)anthranilic acid was prepared in 58% yield. It was a yellow, crystalline substance with m.p. 177-8° C. (from methanol) . ¹H NMR (toluene-d₈): 1.12 (6H, t) , 2.57 (4H, m the two methylene hydrogen atoms are not equivalent in toluene-d₆ due to hindered rotation at the methylene), 6.211 (1H, t), 7.16-7.29 (4H, m) 8.02 (1H, d), 8.92 (1H, s, NH), 11.90 (1H, broad s, COOH).

### EXAMPLE 3

2,6-Dimethylphenylanthranilic acid (24.2 g, 0.1 mol) and 8.5 ml (0.11 mol) of thionyl chloride in 100 ml of dry toluene were heated under reflux in the presence of 0.3 ml DMF before evolution of HCl stopped (3 h). The resulting red solution of the corresponding acyl chloride was added to a solution of 18.7 g (0.1 M) p-toluenesulfonylhydrazine in 150 ml of the same solvent and the reaction mixture was heated under reflux before evolution of HCl stopped again and the suspension of the hydrochloride of p-toluenesulfonylhydrazine disappeared. The mixture was concentrated to 50-60 ml and cooled. The resulting crystalline product was filtered, washed with cold methanol and dried. Yellowish crystals of N-[2-(2′,6′-dimethylphenylamino)benzoyl]-N′-p-toluenesulfonylhydrazine, (XI), with m.p. 220-3° C. (decomp.). Yield 36 g (88%). IR (nu-jol): 3340 (NH), 3180 (NH—NH), 1641 (C=0), 1593, 1567, 1507. ¹H NMR (DMSO-d₆) : 2.03 (6H, s); 2.23 (3H, s); 6.02 (1H, d, J=8.40 Hz); 6.57 (1H,t, J=7.50 Hz); 7.05 (4H, m), 7.20 (2H, d, J=7.70 Hz); 7.63 (1H, d, J=8.00 Hz), 7.74 (2H, d, J=7.60 Hz), 8.45 (1H, s, NH), 9.65 (1H, s, C(O)NH), 10.65 (1H, s, NHSO₂).

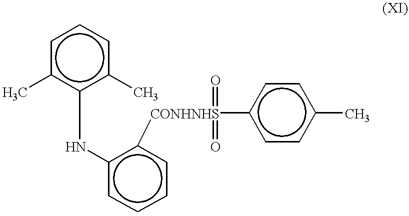

### EXAMPLE 4

In analogy with Example 3, N-[2-(2′,6′-dimethylphenylamino)benzoyl]-N′-p-toluenesulfonylhydrazine, (XII), was prepared from the product of Example 2 in 85% yield. Almost colorless crystals with m.p. 210-5° (de-comp.). ¹H NMR (DMSO-d₆) : 0.95 (6H, t) , 2.25 (3H, s), 2.31 (4H, q), 6.00 (1H, d, J=8.38 Hz), 6.52 (1H, t, J=7.63 Hz), 7.02 (4H, m) , 7.18 (2H, d, J=7.75 Hz) , 7.62 (1H, d, J=8.00 Hz), 7.75 (2H, d, J=7.68 Hz), 8.41 (1H, s, NH), 9.60 (1H, s, C(O)NH), 10.70 (1H, S, NHSO₂).

### EXAMPLE 5

To a solution of 8.2 g (0.02 mol) (XI) in 100 ml of ethylene glycol at 160-165° C. was added anhydrous sodium carbonate in 0.5 g portions before evolution of gaseous products (CO₂ and N₂) stopped. The reaction mixture was kept at the same temperature 5 min, then cooled and poured into 300 ml of water. Dark yellow, oily product, 2-(2′,6′-dimethylphenylamino)benzaldehyde, was extracted with 5×30 ml of benzene and the combined extracts were dried azeotropically. Then 3.40 ml (0.018 M) of 2,6-diisopropylaniline was added and the mixture was heated under reflux with a Dean-Stark trap while 0.32 ml of water was collected. A drop of CF₃COOH was used as a catalyst. The benzene was removed in vacuo and the resulting oily residue was dissolved in 100 ml of hexane. Chromatography on silica gel followed by concentration of the eluate and cooling to −20° C. gave 5.25 g (76%) of 2 (2′,6′-diiospropylphenyliminomethylphenyl)(2″,6″-dimethylphenyl)amine, (XIII), with ¹H NMR (CDCl₃): 1.18 (12H, d), 2.22 (6H, s), 3.10 (2H, sept), 6.28 (1H, d), 6.71 (1H, t), 7.07-7.20 (7H, m), 7.35 (1H, d), 8.36 (1H, s, CH=N), 10.52 (1H, s, NH).

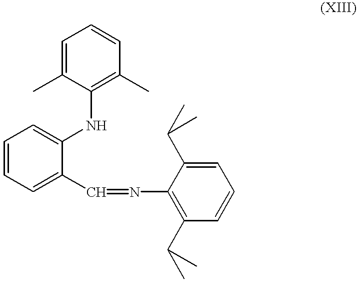

### EXAMPLE 6

In the same manner as in Example 5, starting from 0.02 mol of (XII) and 0.018 M of 2,6-diethylaniline, 2-(2′,6′-diethylphenyliminomethylphenyl)(2″,6″-diethylphenyl)amine, (XIV), was prepared in 60% yield.

### EXAMPLE 7

In a dry box, a solution of 0.8507 g (5.08 mmol) of lithium bis(trimethylsilyl)amide in ether was slowly added to a solution of (XIII) (1.5308 g, 3.98 mmol) in 20 mL of ether. The orange reaction mixture was stirred overnight and filtered through a Celite® plug on a frit. The solvent was removed, rinsed with pentane, and an orange crystalline solid (1.4585 g, 3.16 mmol), the Li salt of (XIII), was obtained in 79% yield. ¹H NMR (C₆D₆): 0.79 (m, CH₂-THF), 1.03 (d, 6H, i-Pr-Me), 1.08 (d, 6H, i-Pr—Me), 2.21 (s, 6H, Me), 2.73 (m, CH₂-THF), 3.10 (m, 2H, i-Pr—CH), 6.24 (t, 1H, Ar—H), 6.39 (d, 1H, Ar—H), 6.90 (m, 2H, Ar—H), 7.02 (m, 4H, Ar—H), 7.10 (m, 2H, Ar—H), 7.98 (s, 1H, C—H). The structure (as a 1:1 complex with THF) was confirmed by X-ray single crystal structure.

### EXAMPLE 8

In a dry box, a solution of 0.3217 g (1.923 mmol ) of lithium bis(trimethylsilyl)amide in ether was slowly added to a solution of (XIV) (0.7394 g, 1.923 mmol) in 20 mL of ether. The yellow reaction mixture was stirred overnight and filtered through a Celite® plug on a frit. The solvent was removed, rinsed with pentane, a yellow solid, the Li salt of (XIV), was obtained. ¹H NMR (C6D₆): 0.75 (m, CH₂-THF), 1.0 (t, 6H, CH₃), 1.08 (t, 6H, CH₃), 2.40 (q, 4H, CH₂), 2.58 (m, 4H, CH₂), 2.70 (m, CH₂-THF), 6.22 (t, 1H, Ar—H), 6.38 (d, 1H, Ar—H), 6.89-7.18 (m, 8H, Ar—H), 7.86 (s, 1H, C-H). One molecule of THF was complexed per molecule of the product.

### EXAMPLE 9

In a dry box, 0.1549 g (0.326 mmol) of methyl methacrylate nickel bromide dimer and the product of Example 7 (0.3015 g, 0.652 mmol) were mixed in 20 mL of THF and stirred for 1 h. The solvent was removed under vacuo and the residue was extracted with pentane. An orange red solid, (XV), was obtained. ¹H NMR (C₆D₆): 0.88 (d, 3H, i-Pr-Me), 0.95 (d, 3H, i-Pr-Me), 1.18 (d, 3H, i-Pr-Me), 1.31 (d, 3H, i-Pr-Me), 1.68 (s, 1H, Allyl-H), 1.91 (s, 1H, Allyl-H), 2.14 (s, 3H, Me), 2.20 (s, 1H, Allyl-H), 2.30 (s, 3H, Me), 2.35 (s, 1H, Allyl-H) , 3.18 (m, 1H, i-Pr-CH) , 3.29 (s, 3H, 0-Me), 3.89 (m, 1H, i-Pr-CH) , 6.25 (t, 1H, Ar-H), 6.41 (d, 1H, Ar—H), 6.80 (t, 1H, Ar—H), 6.88-7.10 (m, 7H, Ar—H), 7.78 (s, 1H, C—H).

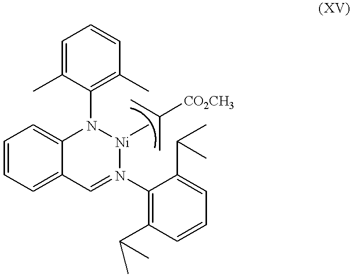

### EXAMPLE 10

In a dry box, 0.0803 g (0.169 mmol) of the methyl methacrylate nickel bromide dimer and the product of Example 8 (0.1483 g, 0.338 mmol) were mixed in 20 mL of THF and stirred for 1 h. The solvent was removed under vacuo and the residue was extracted with pentane. A dark red sticky solid, (XVI) was obtained. ¹H NMR (C₆D₆): 0.90-1.15 (m, 12H, Me), 1.64 (s, 1H, Allyl-H), 1.70 (s, 1H, Allyl-H), 2.10 (s, 1H, Allyl-H), 2.18 (s, 1H, Allyl-H), 2.52 (m, 4H, CH₂), 2.82 (m, 4H, CH₂), 3.20 (s, 3H, O-Me), 6.18 (t, 1H, Ar—H), 6.35 (d, 1H, Ar—H), 6.70 (t, 1H, Ar—H), 6.82-7.15 (m, 7H, Ar—H) 7.57 (s, 1H, C—H).

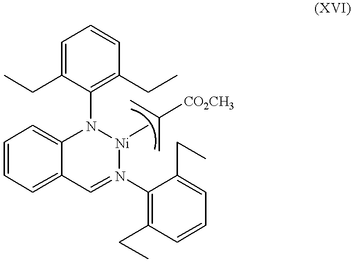

### EXAMPLES 11-17

### Polymerization of Ethylene

In a dry-box, 0.02 mmol of the catalyst (Ni complex) was placed in a glass vial and dissolved in 5 mL of 1,2,4-trichlorobenzene. The vial was cooled to −30° C. in a drybox freezer. MMAO (3.7 mL, 1.7M in heptane) was added to the vial on top of the frozen solution, then the vial was capped, sealed and placed into a shaker tube which was removed from the drybox and placed in a shaker apparatus. It was then shaken mechanically under 3.45 MPa of ethylene for about 18 h. The reaction mixture was slowly poured into 100 mL of methanol a solution of con. HCl (10% volume con. HCl). The mixture was stirred overnight and filtered. The polymer was collected on a frit, washed with acetone and dried in vacuo.

If the cocatalyst was a borane, catalyst and cocatalyst were placed in the reaction vial and cooled at −30° C., then 1,2,4-trichlorobenzene was added. Results of all the polym- erizations are given in Table 1.

TABLE 1

| | | | | Productivity | | | |
|---|---|---|---|---|---|---|---|
| | | Cocatalyst | | (mol PE/mol | | | Me/ |
| Ex. | Catalyst | (equiv.) | PE (g) | Catalyst) | MI | M_{w} (M_{w}/Mₙ) | 1000CH₂ |
| 11 | (XVI) | B(C₆F₅)₃ (20) | 0.1043 | 183 | | 78876 (127.25) | 49.67 |
| | | | | | | bimodal | |
| 12 | (XVI) | MMAO (300) | 1.1245 | 1871 | 0 | | 9.10 |
| 13 | (XVI)^{a} | BPh₃ (20) | 0 | 0 | | | |
| 14 | (XVI)^{a} | B(C₆F₅)₃ (20) | 0.0728 | 122 | | | 77.81 |
| 15 | (XV)^{a} | BPh₃ (20) | 0 | 0 | | | |
| 16 | (XV)^{a} | B(C₆F₅)₃ (20) | 0.0599 | 130 | | | 39.43 |
| 17 | (XV) | MMAO (300) | 0 | 0 | | | |

^{a}1.38 MPa ethylene

What is claimed is:

1. A process for the polymerization of olefins, comprising the step of contacting, at a temperature of about -100° C. to about +200° C., one or more monomers selected from the group consisting of ethylene and an olefin of the formula H₂C═CH(CH₂)ₙG (XVII), with a Ni, Pd, Co, Fe, Cr, V, Zr, Ti or Hf complex of an anion of the formula (I) 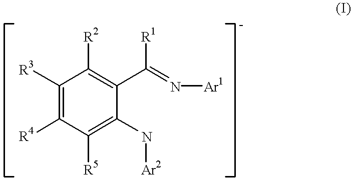
wherein:
R¹ is hydrogen, hydrocarbyl or substituted hydrocarbyl;
R²,R³, R⁴, and R are each independently hydrogen, hydrocarbyl, substituted hydrocarbyl or a functional group, provided that R¹ and R2 taken together may form a ring, or any two of R², R³, R⁴ and R⁵ vicinal to one another may form a ring;
Ar¹ and Ar² are each independently aryl or substituted aryl, provided that R⁵ and Ar² taken together may form a ring;
n is an integer of 1 or more;
G is hydrogen, —CO₂R¹⁶, or —C(O)NR¹⁶₂; and
each R¹⁶ is independently hydrogen, hydrocarbyl or substituted hydrocarbyl.

2. The process of claim 1, wherein said one or more monomers and said complex are contacted in the further presence of a cocatalyst.

3. The process of claim 1, wherein:
R¹ is hydrogen; and/or
R², R³, R⁴, and R⁵ are hydrogen; and/or
Ar¹ and Ar² are each independently 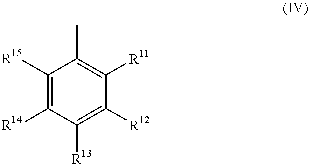
wherein each of R¹¹, R¹², R¹³, R¹⁴ and R¹⁵ are independently hydrogen, hydrocarbyl, substituted hydrocarbyl or a functional group, provided that any two of R¹¹, R¹², R¹³, R¹⁴ and R¹⁵ vicinal to one another taken together may form a ring.

4. The process of claim 1, wherein said complex is a Ni or Pd complex.

5. The process of claim 1, wherein said one or more monomers comprises ethylene.

6. A process for the polymerization of olefins, comprising the step of contacting, at a temperature of about −100° C. to about +200° C., one or more monomers selected from the group consisting of ethylene and H₂C═CH(CH₂)ₙG (XVII), with a compound of the formula (II) 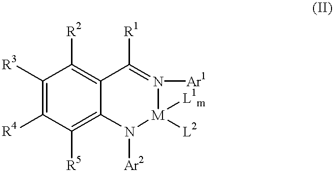
wherein:
R¹ is hydrogen, hydrocarbyl or substituted hydrocarbyl;
R², R³, R⁴, and R⁵ are each independently hydrogen, hydrocarbyl, substituted hydrocarbyl or a functional group, provided that R¹ and R² taken together may form a ring, or any two of R², R³, R⁴ and R⁵ vicinal to one another may form a ring;
Ar¹ and Ar² are each independently aryl or substituted aryl, provided that R⁵ and Ar² taken together may form a ring;
M is Ni, Pd, Co, Fe, Cr, V, Ti, Zr or Hf;
m is an integer equal to the valence of M minus 1;
n is an integer of 1 or more;
G is hydrogen, —CO₂R¹⁶, or —C(O)NR¹⁶₂;
R16 is hydrogen, hydrocarbyl or substituted hydrocarbyl; and
each L¹ is independently a monodentate monoanionic ligand and at least for one of L¹ an ethylene molecule may insert between L¹ and M, and L² is a monodentate neutral ligand which may be displaced by ethylene or an empty coordination site, provided that an L and L² taken together may be a monoanionic bidentate ligand and at least for one of these monoanionic bidentate ligands ethylene may insert between said monoanionic bidentate ligand and M.

7. The process of claim 6, wherein said one or more monomers and said compound are contacted in the further presence of a cocatalyst.

8. The process of claim 6, wherein:
R¹ is hydrogen; and/or
R², R³, R⁴, and R⁵ are hydrogen; and/or
Ar¹ and Ar² are each independently 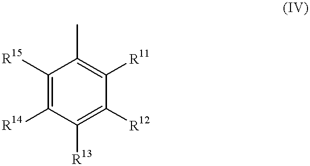
wherein each of R¹¹, R¹², R¹³, R¹⁴ and R¹⁵ are independently hydrogen, hydrocarbyl, substituted hydrocarbyl or a functional group, provided that any two of R¹¹, R¹², R¹³, R¹⁴ and R¹⁵ vicinal to one another taken together may form a ring.

9. The process of claim 6, wherein M is Ni or Pd.

10. The process of claim 6, wherein said one or more monomers comprises ethylene.

11. A compound of the formula (XVIII) 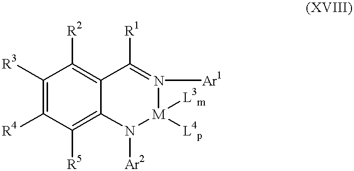
wherein:
R¹ is hydrogen, hydrocarbyl or substituted hydrocarbyl;
R², R³, R⁴, and R⁵ are each independently hydrogen, hydrocarbyl, substituted hydrocarbyl or a functional group, provided that R¹ and R² taken together may form a ring, or any two of R², R³, R⁴ and R⁵ vicinal to one another may form a ring;
Ar¹ and Ar² are each independently aryl or substituted aryl, provided that R⁵ and Ar² taken together may form a ring;
M is Ni, Pd, Co, Fe, Cr, V, Ti, Zr or Hf;
m is an integer equal to the valence of M minus 1;
p is 0 or 1; and
each L³ is independently a monodentate monoanionic ligand, and L⁴ is a monodentate neutral ligand or an empty co-ordination site, provided that an L³ and L⁴ taken together may be a monoanionic bidentate ligand.

12. The compound of claim 11, wherein:
R¹ is hydrogen; and/or R², R³, R⁴, and R⁵ are hydrogen; and/or Ar¹ and Ar² are each independently 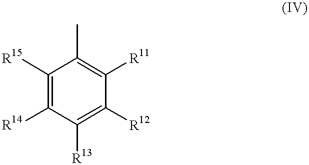
wherein each of R¹¹, R¹², R¹³,R¹⁴ and R¹⁵ are independently hydrogen, hydrocarbyl, substituted hydrocarbyl or a functional group, provided that any two of R¹¹, R¹², R¹³, R¹⁴ and R¹⁵ vicinal to one another taken together may form a ring.

13. The compound of claim 11, wherein M is Ni or Pd.

14. A compound of the formula (III) 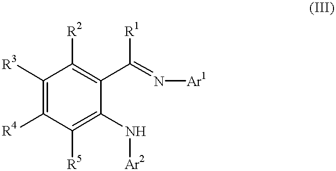
wherein:
R¹ is hydrogen, hydrocarbyl or substituted hydrocarbyl;
R², R³, R⁴, and R⁵are each independently hydrogen, hydrocarbyl, substituted hydrocarbyl or a functional group, provided that R¹ and R² taken together may form a ring, or any two of R², R³, R⁴ and R⁵ vicinal to one another may form a ring;
Ar¹ and Ar² are each independently aryl or substituted aryl, provided that R⁵ and Ar² taken together may form a ring.

15. The compound of claim 14, wherein:
R¹ is hydrogen; and/or
R², R³, R⁴, and R⁵ are hydrogen; and/or
Ar¹ and Ar2 are each independently 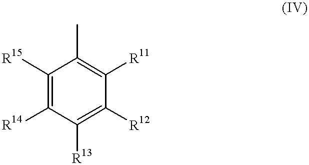
wherein each of R¹¹, R¹², R¹³, R¹⁴ and R¹ are independently hydrogen, hydrocarbyl, substituted hydrocarbyl or a functional group, provided that any two of R¹¹, R¹², R¹³, R¹⁴ and R¹⁵ vicinal to one another taken together may form a ring.

16. An anion of the formula (I) 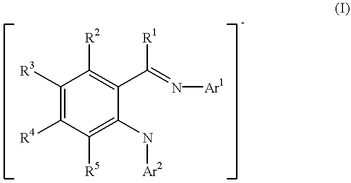
wherein:
R¹ is hydrogen, hydrocarbyl or substituted hydrocarbyl;
R², R³, R⁴, and R⁵ are each independently hydrogen, hydrocarbyl, substituted hydrocarbyl or a functional group, provided that R¹ and R² taken together may form a ring, or any two of R², R³, R⁴ and R⁵ vicinal to one another may form a ring;
Ar¹ and Ar² are each independently aryl or substituted aryl, provided that R⁵ and Ar² taken together may form a ring.

17. The anion of claim 16, wherein:
R¹is hydrogen; and/or
R², R R⁴, and R⁵ are hydrogen; and/or
Ar¹ and Ar² are each independently 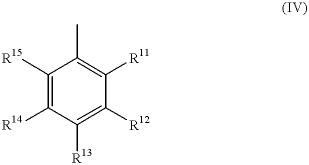
wherein each of R¹¹, R¹², R¹³, R¹⁴ and R are independently hydrogen, hydrocarbyl, substituted hydrocarbyl or a functional group, provided that any two of R¹¹, R¹², R¹³, R¹⁴ and R¹⁵ vicinal to one another taken together may form a ring.
